(19) United States
(12) Patent Application Publication
(10) Pub. No.: US 2008/0228522 A1
(43) Pub. Date: Sep. 18, 2008

(54) ENTERPRISE MEDICAL IMAGING AND INFORMATION MANAGEMENT SYSTEM WITH CLINICAL DATA MINING CAPABILITIES AND METHOD OF USE

(75) Inventors: Shari Renae Davis, Brandon, SD (US); Christopher Scott Livermont, Sioux Falls, SD (US); Neal L. Nachtigall, Sioux Falls, SD (US); Greg Alan Wessels, Sioux Falls, SD (US)

Correspondence Address: MCANDREWS HELD & MALLOY, LTD, 500 WEST MADISON STREET, SUITE 3400, CHICAGO, IL, 60661, US

(73) Assignee: GENERAL ELECTRIC COMPANY, Schenectady, NY (US)

(21) Appl. No.: 11/749,602

(22) Filed: May 16, 2007

Related U.S. Application Data
(60) Provisional application No. 60/894,375, filed on Mar. 12, 2007.

(51) Int. Cl. G06Q 50/00; G06F 17/30

(52) U.S. Cl. 705/2; 707/104.1

(57) ABSTRACT

Certain embodiments of the present invention provide improved clinical workflow using a healthcare imaging and information management system and method with data mining capabilities. Certain embodiments provide a healthcare imaging and information management system with data mining capabilities. The system includes a user interface accepting user input and displaying information related to a patient. The system also includes a data access layer gathering data related to the patient from a plurality of data sources. The system further includes a data mining service processing the data for provision via the user interface. Certain embodiments provide a method for clinical data mining including requesting data for a patient; accessing a plurality of data sources to retrieve data related to the patient; gathering data from the plurality of data sources; processing the data; formatting the data for a user; and providing the data to the user.

### RELATED APPLICATIONS

This application claims priority to a provisional application entitled “Enterprise Medical Imaging and Information Management System with Clinical Data Mining Capabilities and Method of Use,” filed on Mar. 12, 2007, as Ser. No. 60/894,375, which is herein incorporated by reference in its entirety.

### FEDERALLY SPONSORED RESEARCH OR DEVELOPMENT

[Not Applicable]

### MICROFICHE/COPYRIGHT REFERENCE

[Not Applicable]

### BACKGROUND OF THE INVENTION

The present invention generally relates to an image and information management system. In particular, the present invention relates to an image and information management system with clinical data mining capabilities to deliver evidence-based medicine based upon individual patient data trends.

Healthcare environments, such as hospitals or clinics, include clinical information systems, such as hospital information systems (HES), radiology information systems (RIS), clinical information systems (CIS), and cardiovascular information systems (CVIS), and storage systems, such as picture archiving and communication systems (PACS), library information systems (LIS), and electronic medical records (EMR). Information stored may include patient medical histories, imaging data, test results, diagnosis information, management information, and/or scheduling information, for example. The information may be centrally stored or divided among a plurality of locations. Healthcare practitioners may desire to access patient information or other information at various points in a healthcare workflow. For example, during surgery, medical personnel may access patient information, such as images of a patient's anatomy, that are stored in a medical information system. Alternatively, medical personnel may enter new information, such as history, diagnostic, or treatment information, into a medical information system during an ongoing medical procedure.

During a healthcare delivery cycle, evidence-based medicine, both pre-procedurally and post-procedurally, requires a synopsis of a patient's cardiac medical record. A medical record synopsis is used for a physician to prepare for an upcoming case and can also be used as a post-procedural comparative tool. Use of evidence-based medical can be important for safe and effective patient treatment.

For example, a cardiac physician may want to review findings from previous cardiac cases in order to compare and trend relevant data. Comparing and trending the data allows the physician to track disease progression and/or disease regression. Pre-procedurally, the physician may be better prepared and informed of relevant clinical data that is pertinent to an upcoming procedure. Post-procedurally, the physician has the ability to compare and trend findings within the scope of evidence-based medicine.

Currently, the steps required to achieve the above-described interactions consist of locating the patient's charts by pulling the charts from the patient's bedside and/or by undertaking a lengthy search through medical records. Once the charts are obtained, the physician must sift though potentially several years of documentation that is not scoped to cardiac specific procedures. Alternatively, on the day of the patient's procedure, a nurse scans the patient's medical record to find the high level details of the patient's history and current visit, and reports verbally to the physician before beginning the procedure.

Comparing and trending current as well as historical data involves significant research across a patient's charts. Such cross-chart analysis is very time consuming. An ability to reduce the number of actions required for trending and comparison across a patient's charts by interested parties would be highly desirable. An ability to reduce a number of ineffective actions in comparing and trending patient data would be highly desirable. Furthermore, systems and methods that help reduce a waiting time to obtain necessary information and perform a collaboration would result in more efficient and effective healthcare delivery.

Thus, there is a need for systems and methods to improve clinical workflow via image and information management with clinical data mining capabilities.

### BRIEF SUMMARY OF THE INVENTION

Certain embodiments of the present invention provide improved clinical workflow using a healthcare imaging and information management system and method with data mining capabilities. Certain embodiments provide a healthcare imaging and information management system with data mining capabilities. The system includes a user interface accepting user input and displaying information related to a patient. The system also includes a data access layer gathering data related to the patient from a plurality of data sources. The system further includes a data mining service processing the data for provision via the user interface.

Certain embodiments provide a method for clinical data mining in an imaging and information management system. The method includes requesting data for a patient. The method also includes accessing a plurality of data sources to retrieve data related to the patient. The method further includes gathering data from the plurality of data sources. Additionally, the method includes processing the data, and formatting the data for a user. The method includes providing the data to the user.

Certain embodiments provide a computer-readable storage medium including a set of instructions for a computer. The set of instructions includes a user interface routine accepting user input and displaying information related to a patient. The set of instructions also includes a data access layer gathering data related to the patient from a plurality of data sources. The set of instructions further includes a data mining service processing the data for provision via the user interface.

### BRIEF DESCRIPTION OF SEVERAL VIEWS OF THE DRAWINGS

FIG. 1 illustrates an image management and communication system used in accordance with an embodiment of the present invention.

FIG. 2 shows a graph representing a stenosis percentage of a given valve over multiple patient visits provided to a physician in accordance with an embodiment of the present invention.

FIG. 3 illustrates an exemplary interface providing patient information and data mining results to a user.

FIG. 4 shows an interface providing visual indicators of data relationships in accordance with an embodiment of the present invention.

FIG. 5 illustrates patient search and selection capability via the interface in accordance with an embodiment of the present invention.

FIG. 6 illustrates an exemplary view of a retrieved patient's history aggregated from a variety of sources in accordance with an embodiment of the present invention.

FIG. 7 illustrates measurement analysis data shown to a user in accordance with an embodiment of the present invention.

FIG. 8 depicts exemplary disease analysis data provided to a practitioner to aid in pre-, intra- and/or post-operative planning in accordance with an embodiment of the present invention.

FIG. 9 illustrates a representation of complementary information provided to a user via the interface in accordance with an embodiment of the present invention.

FIG. 10 illustrates both qualitative and quantitative data provided to help increase information available for practitioner decision-making in accordance with an embodiment of the present invention.

FIG. 11 illustrates data depicted via a variety of graphics in accordance with an embodiment of the present invention.

FIG. 12 illustrates a case interaction for a patient in accordance with an embodiment of the present invention.

FIG. 13 illustrates a physician report generated and displayed in accordance with an embodiment of the present invention.

FIG. 14 illustrates an example representation of an architecture for clinical data mining and analysis in accordance with an embodiment of the present invention.

FIG. 15 illustrates a flow diagram for a method for patient data mining in accordance with an embodiment of the present invention.

The foregoing summary, as well as the following detailed description of certain embodiments of the present invention, will be better understood when read in conjunction with the appended drawings. For the purpose of illustrating the invention, certain embodiments are shown in the drawings. It should be understood, however, that the present invention is not limited to the arrangements and instrumentality shown in the attached drawings.

### DETAILED DESCRIPTION OF THE INVENTION

Certain embodiments provide an Enterprise Medical Imaging and Information Management System (EMIIMS) including clinical data mining capabilities to deliver evidence based medicine based upon individual patient data trends. Certain embodiments provide an EMIIMS with an ability to track certain pieces of information that can change over time. Certain embodiments provide an automated method for a computer to mine a database and track trends (e.g., cardiology can track ejection fractions over time in different modalities and circumstances). In certain embodiments, alarms and/or logging may be triggered manually and/or automatically when a data trend is going in a certain direction, for example. Certain embodiments provide data mining and analysis of mined data to identify trends. Certain embodiments delineate when a trend is reaching a point such that the physician should be alerted or presented with the data in some way.

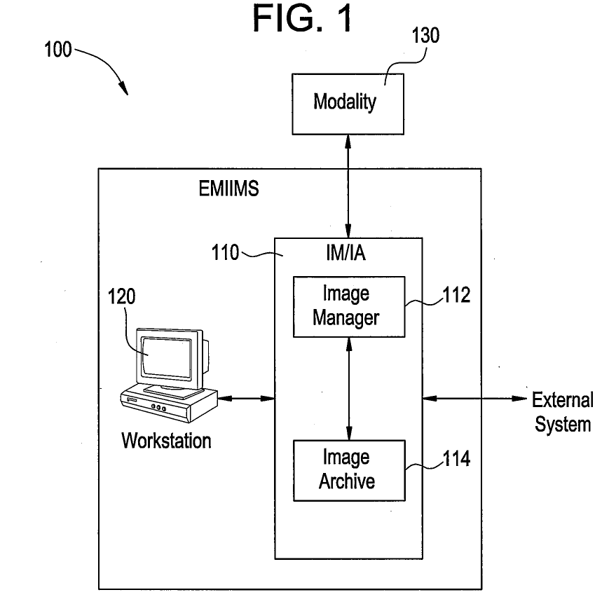

FIG. 1 illustrates an image management and communication system 100 used in accordance with an embodiment of the present invention. The system 100 includes an image management system 110, an interface 120, and/or a modality 130, for example. The image management system 110 may include an image manager 112 and an image archive 114, for example. The system 100 may communicate and/or connect to one or more external systems, for example.

In an embodiment, the image management and communication system 100 is an enterprise medical imaging and information management system (EMIIMS). The EMIIMS combines capabilities of an image management system, an image archive system with integrated workflow and exam reading capabilities for a medical enterprise, for example.

The image management system 110 is capable of performing image management, image archiving, exam reading, exam workflow, and/or other medical enterprise workflow tasks, for example. In an embodiment, the system 110 is or includes a Picture Archiving and Communication System (PACS), a healthcare or hospital information system (HIS), a radiology information system (RIS), a clinical information system (CIS), a cardiovascular information system (CVIS), a library information system (LIS), order processing system, and/or an electronic medical record (EMR) system, for example. The image management system 110 may include an image manager 112 for image management and workflow. The image management system 110 may also include an image archive 114 for image storage and retrieval.

The interface 120, such as a workstation (e.g., a PACS workstation) or other data processing device (e.g., laptop, tablet computer, personal digital assistant, handheld computer, cellular phone, etc.), may be used to access (e.g., input and retrieve data) the system 110. The interface 120 may communicate with the image management system 110 via a communication medium, such as a wired or wireless modem, cellular transmission, infrared transmission, Ethernet, fire wire, Internet, virtual private network, public switched telephone network, dial-up, local area network, and/or wide area network, for example, for example. Vocal/subvocal command and/or other forms of communication and control may be used to interface with the system 100. In an embodiment, a password and/or other authentication, such as voice or other biometric authentication, may be used to establish a connection between the system 110 and the interface 120. In an embodiment, the interface 120 may be integrated with the system 110.

The image management system 110 interacts with one or more modalities 130, such as an x-ray system, computed tomography (CT) system, magnetic resonance (MR) system, ultrasound system, digital radiography (DR) system, positron emission tomography (PET) system, single photon emission computed tomography (SPECT) system, nuclear imaging system, and/or other modality. The image management system 110 may acquire image data and related data from the modality 130 for processing and/or storage. The image management system 110 may receive examination data, such as image data, and additional information from the modality 130 and/or the interface 120. Additional information may indicate findings within the image data, diagnosis information, treatment information, and/or consultation or referral information, for example.

In certain embodiments, the imaging and information management system 110 is integrated with clinical data mining capabilities. Using data mining, data may be analyzed from different perspectives and summarized into useful or relevant information, for example. Data mining helps allow users to analyze data from many different dimensions or angles, categorize the data, and summarize the relationships identified, for example. Clinical data mining may be used, for example, to identify correlations or patterns among fields in relational and/or other databases. The system 110 may include a capability to compare data across modalities and/or data sources for a particular patient, for example.

In certain embodiments, the system 110 and/or interface 120 includes a portal in which information for a patient may be accessed. Once a patient is identified, a user interface is presented. The user interface includes patient demographics, current order information, current patient information (e.g., medication, allergies, chief complaint, labs, etc.), historical information (e.g., renal failure, family history, computer aided diagnosis (CAD), previous invasive and/or non-invasive procedures, etc.), dynamic measurement analysis, and/or configurable normal values, for example.

In certain embodiments, the system 110 and/or interface 120 includes a data mining component. The data mining component provides a dynamic snapshot of vital measurements and relevant findings across all cases in the information system 110 for a particular patient, for example. The data mining component supports access to multiple data sources, cross-modality comparison, cross-data source comparisons and the like. In certain embodiments, the data mining components allows data elements to be registered or subscribed so that a user, administrator and/or system setting may specify how to retrieve certain data (e.g., database, Extensible Markup Language (XML), etc.), what functions can be applied to certain data, in which modality(ies) and/or data source(s) can a certain data element be found, whether data is enumerated and/or numeric data, etc. The data mining component may be used for pre-, post-, and/or intra-procedural data mining.

Data mining in conjunction with the system 100 helps improve efficient due to reduced steps involving users, such as medical staff, to retrieve historical cardiac data and compare findings from previous procedures, which was previously done manually. The data mining tool retrieves, calculates and correlates data automatically. The data mining tool may provide visual indicators of data relationships along with the data itself, for example. Additionally, the data mining tool helps provide a more efficient workflow to compare and trend data, which allows a physician or other healthcare practitioner to track disease progression and/or disease regression within the scope of evidence-based medicine.

Certain embodiments provide intelligent clinical data mining. In intelligent data mining, data sets are generated based on relevant case information. The data mining tool may mine data across all cases for a particular patient which includes different modalities and potentially multiple data sources. The data mining tool provides real-time (or substantially real-time) analysis of vital measurements and relevant findings across all cases for a particular patient that helps improve a clinical ability to predict, diagnose and/or treat the patient.

In certain embodiments, the data mining tool has multiple implementation settings. For example, in a physician reporting setting, the tool is context-sensitive and/or attribute specific, where clinical staff wants to review all historical data points for a particular element. In a patient dashboard setting, for example, the tool provides an ability to review patient demographics, current information (e.g., medications, allergies, chief complaint, labs, etc.), current order information, and/or historical data, along with a dynamic snapshot and/or measurement analysis of mined data, for example. The patient dashboard may also be context sensitive and provide a single, unified indicator of patient information.

In certain embodiments, the data mining tool provides interactive graphing capabilities for mined data elements. For example, a user can select different data points to be included in the graph, indicate a type of graph (e.g., line or bar), and select a size of the graph. A user may select different function(s) to be applied to a specific data element such as change or difference, average, min, max, range, etc. A user may utilize the data mining tool to compare qualitative and/or quantitative data, for example.

Data mining may be applicable to a wide variety of clinical areas and specialties, such as cardiology, disease progression/regression, evidence-based medicine, radiology, mammography (e.g., track mass growth/reduction), interventional neurology, radiology, cardiology (e.g., measure stenosis progression of Carotid Artery disease), hematology, oncology, etc.

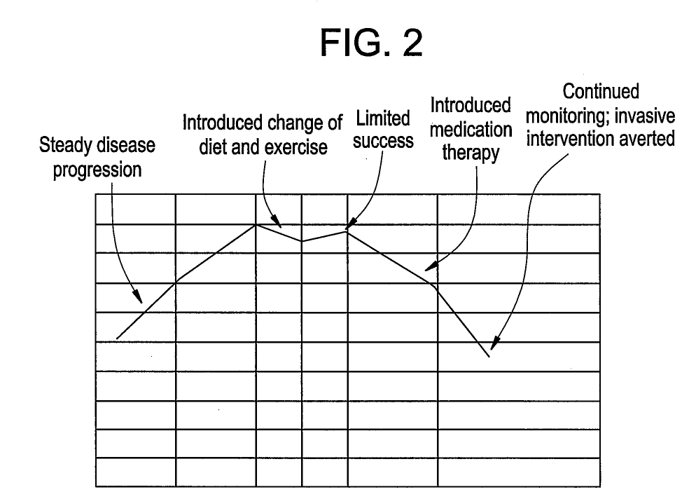

Certain embodiments provide real-time or substantially real-time analysis that helps improve a clinical ability to predict, diagnose and treat. Providing better tools and better access to improved information leads to better decisions. Through trending and comparing of clinical data, the data mining tool has the ability to generate graphs to give a user a visual representation of different data elements. For example, as shown in FIG. 2, a graph representing a stenosis percentage of a given valve over multiple patient visits is provided to a physician. Rather than sifting through multiple procedural reports and/or writing custom reports, the physician is provided with real-time analysis to help predict, diagnose and treat the patient.

For example, a cardiac physician may want to review findings from previous cardiac cases in order to compare and trend relevant data. Comparing and trending the data allows the physician to track disease progression and/or disease regression. Pre-procedurally, the physician is provided with an ability to be better prepared and informed of relevant clinical data that is pertinent to an upcoming procedure. Post-procedurally, the physician is provided with an ability to compare and trend the findings within the scope of evidence-based medicine to track disease progression or regression and potentially recommend other therapies.

In certain embodiments, a portal (e.g., a personal computer and/or Web-based portal) or other interface may be used to facilitate access to information, patient care and/or practice management, for example. Information and/or functionality available via the portal may include one or more of order entry, laboratory test results review system, patient information, clinical decision support, medication management, scheduling, electronic mail and/or messaging, medical resources, etc.

In certain embodiments, the portal serves as a central interface to access information and applications, for example. Data may be viewed through the Web-based portal or viewer, for example. Additionally, data may be manipulated and propagated using the portal, for example. Data may be generated, modified, stored and/or used and then communicated to another application or system to be modified, stored and/or used, for example, via the portal.

The portal may be accessible locally (e.g., in an office) and/or remotely (e.g., via the Internet and/or other private network or connection), for example. The portal may be configured to help or guide a user in accessing data and/or functions to facilitate patient care and practice management, for example. In certain embodiments, the portal may be configured according to certain rules, preferences and/or functions, for example. For example, a user may customize the portal according to particular desires, preferences and/or requirements.

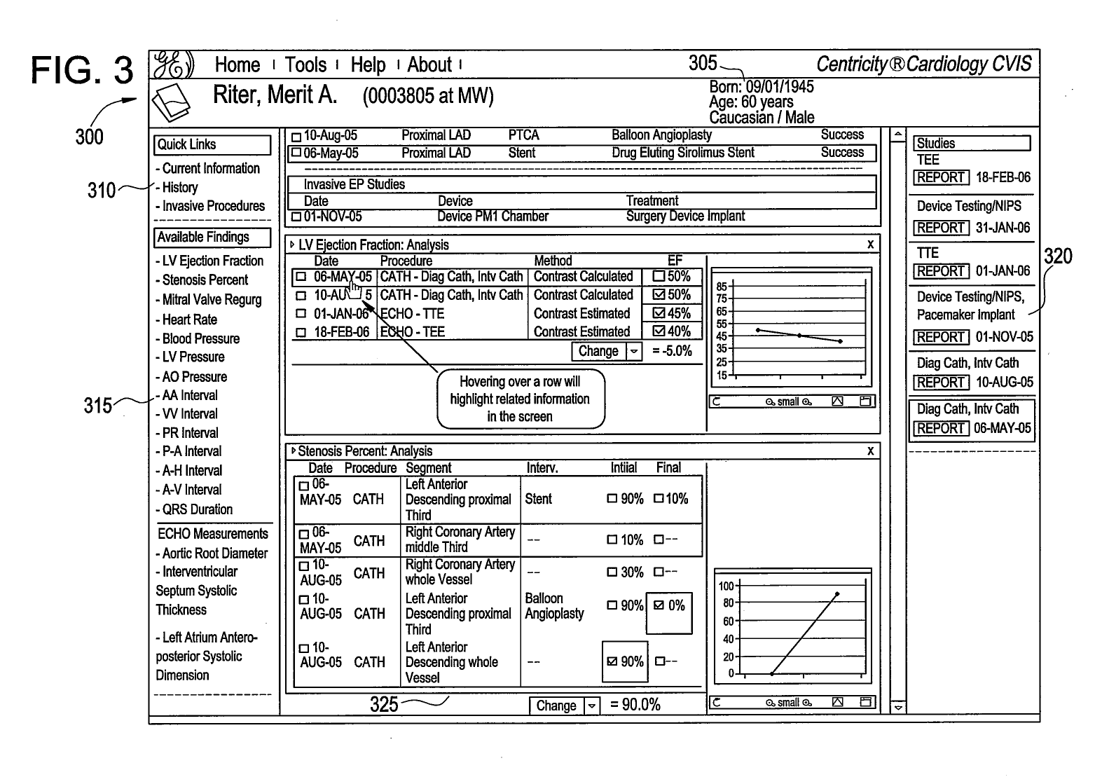

FIG. 3 illustrates an exemplary interface 300 providing patient information and data mining results to a user. The interface 300 combines and provides a variety of information related to a particular patient via a common portal for a user. The interface 300 may provide data including identification information 305 for a patient, quick links 310 to information and/or services, a selectable listing of available findings 315, a listing of available studies 320, and more in-depth views of analysis data 325, for example. More in-depth analysis 325 may include textual as well as graphical information, for example.

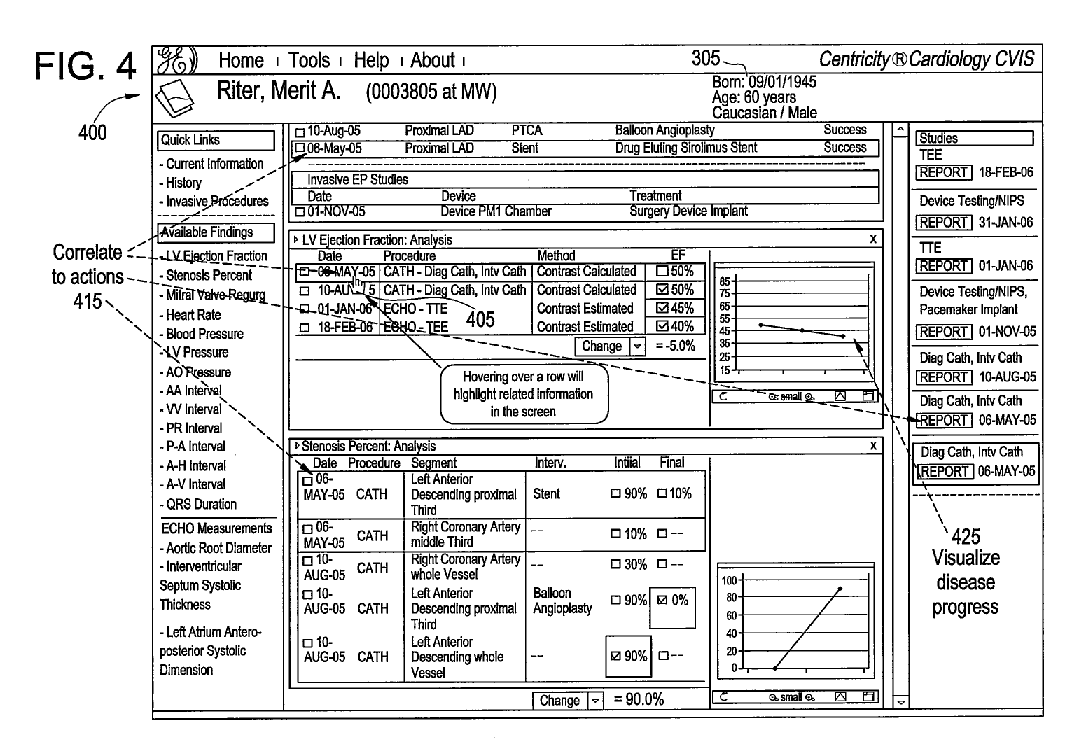

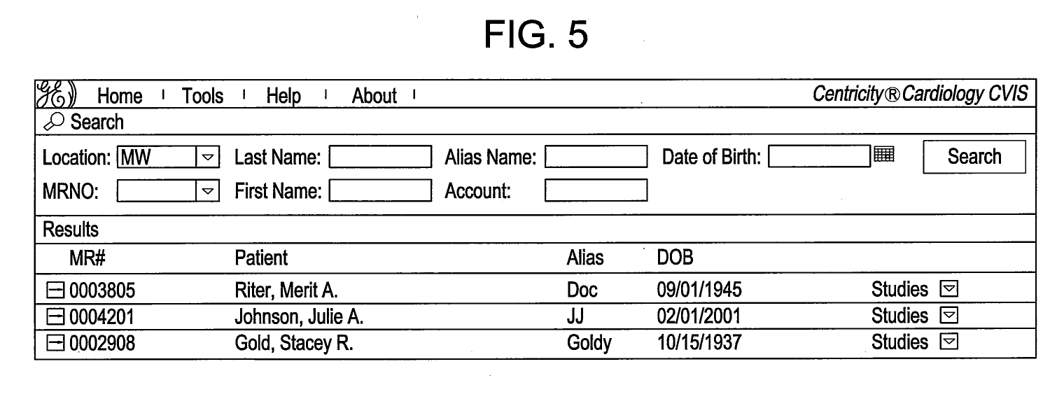

In certain embodiments, as shown in FIG. 4, an interface provides visual indicators of data relationships. For example, a user can hover (e.g., position a cursor) over a particular data element, and all data elements relating to the same case are made apparent to the user. As shown in FIG. 4, a cursor 405 may be positioned over a data element displayed on the interface 400. When the cursor 405 is positioned over a data element, associated data is highlighted as indicated at 415, for example. As an example, a user selects a particular ejection fraction analysis via the cursor 405. Related stenosis information, procedure information, studies, etc. are also highlighted for ease of reference by a user. In addition to textual data, graphical data, such as a bar or line graph 425, may be provided to a user for visual indication of disease progression, regression and/or other trend, for example.

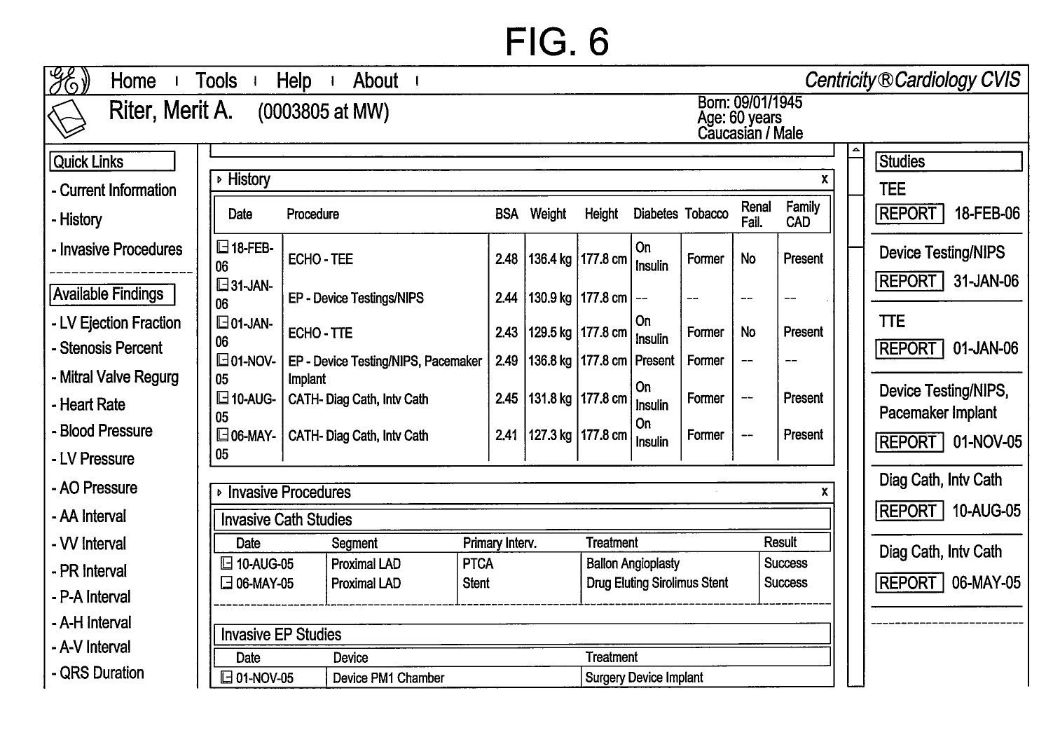

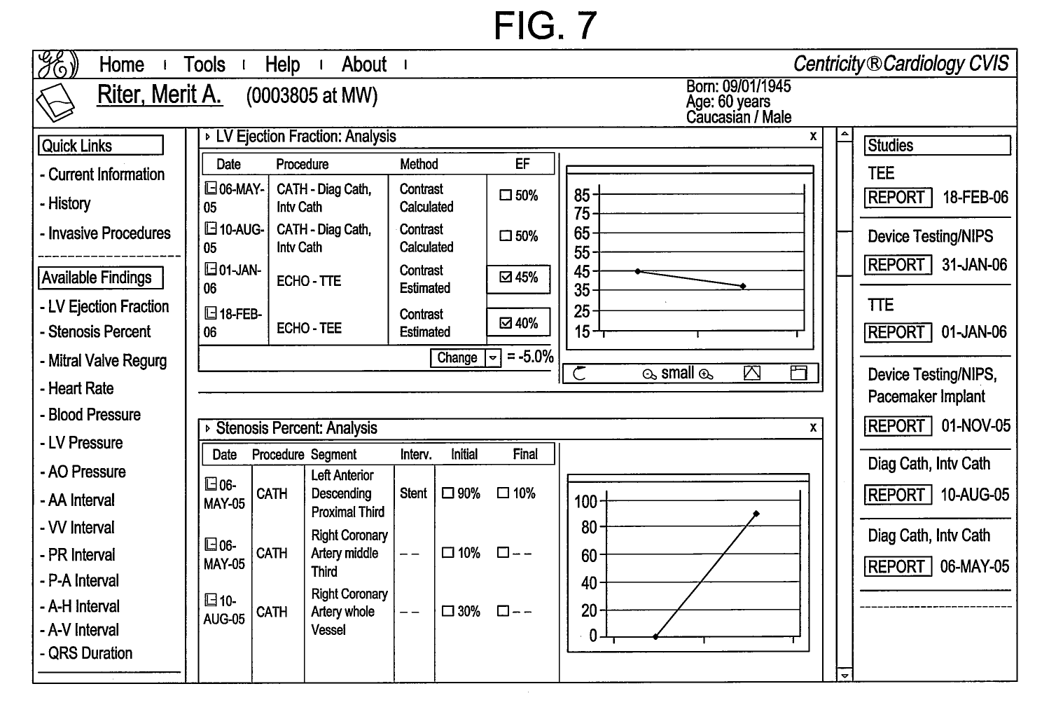

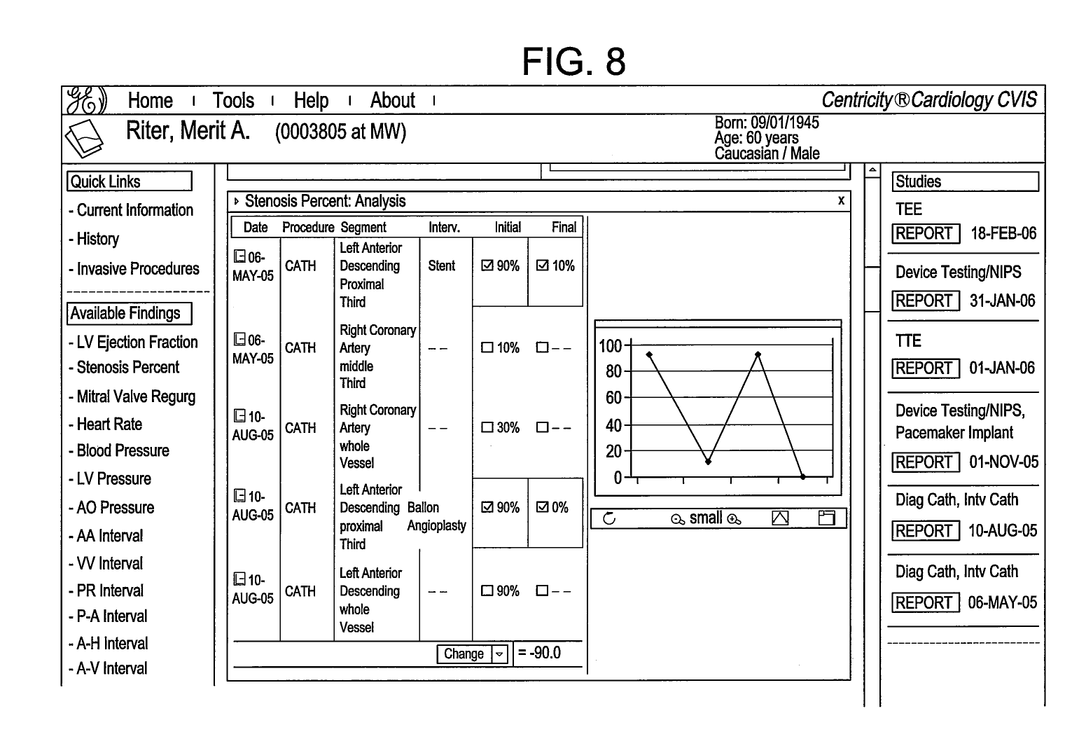

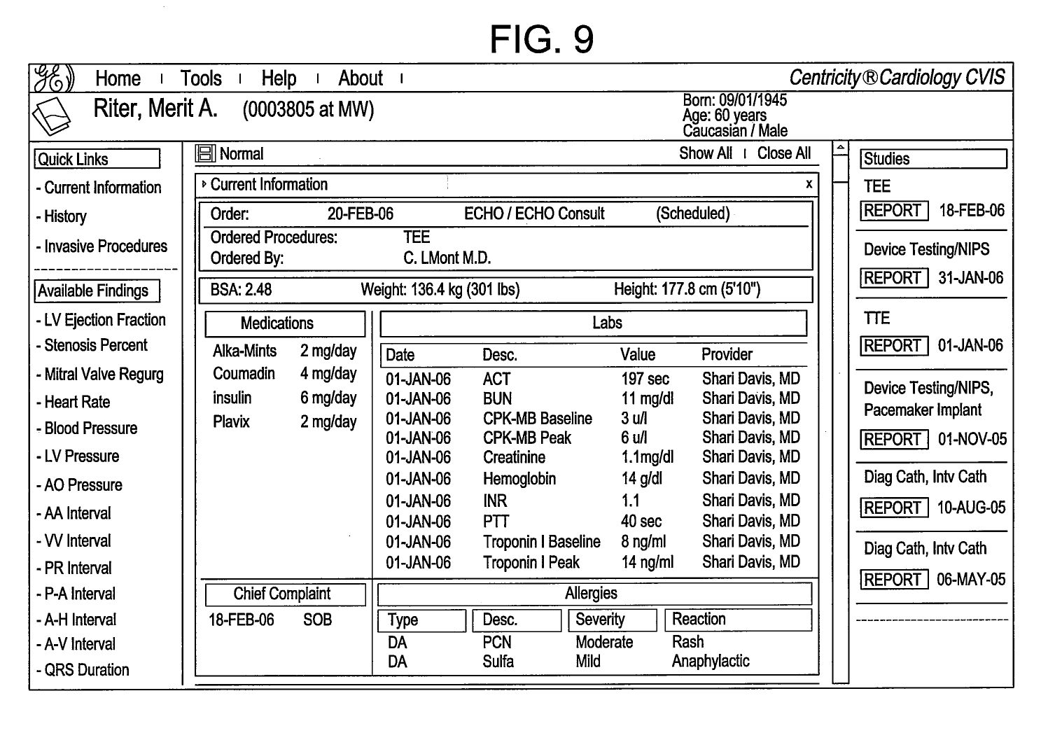

FIGS. 5-13 provide further examples of user interface options shown in more detail in accordance with embodiments of the present invention. For example, FIG. 5 illustrates patient search and selection capability via the interface. A user may retrieve information for one or more users or groups of users using one or more pieces of identifying information via the interface, for example. FIG. 6 illustrates an exemplary view of a retrieved patient's history aggregated from a variety of sources in accordance with an embodiment of the present invention. In FIG. 7, measurement analysis data is provided to a user. FIG. 8 depicts exemplary disease analysis data provided to a practitioner to aid in pre-, intra- and/or post-operative planning. As shown in FIG. 9, complementary or supporting information, such as order information, medication listing, lab results, allergies, etc., may be provided to a user via the interface.

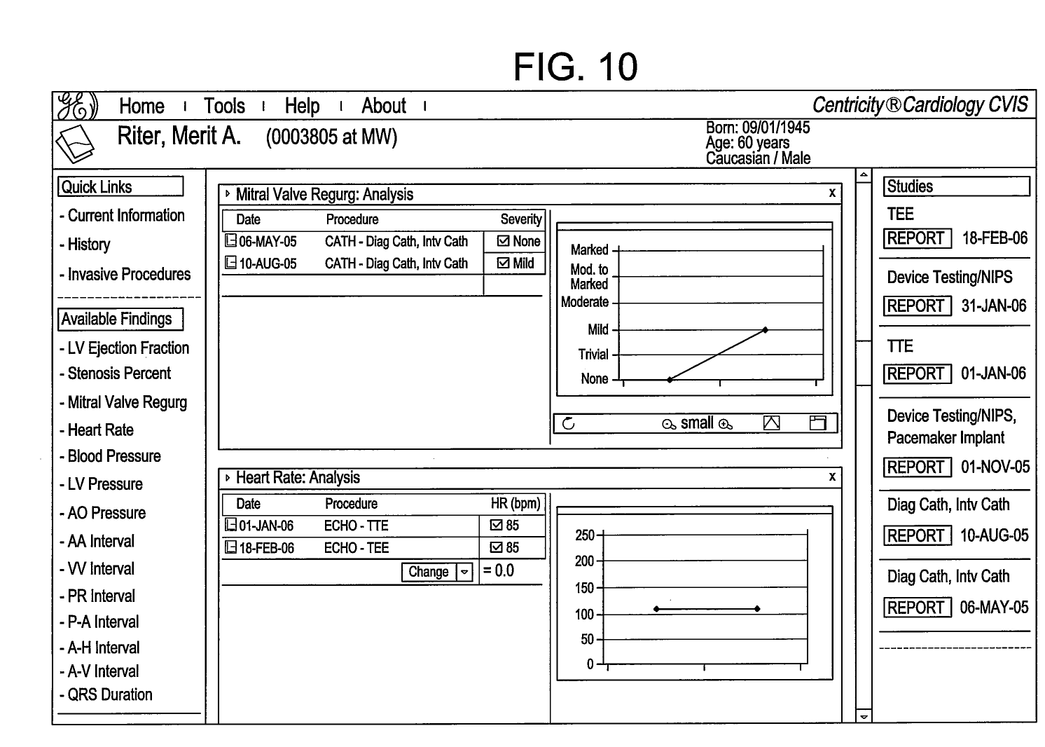

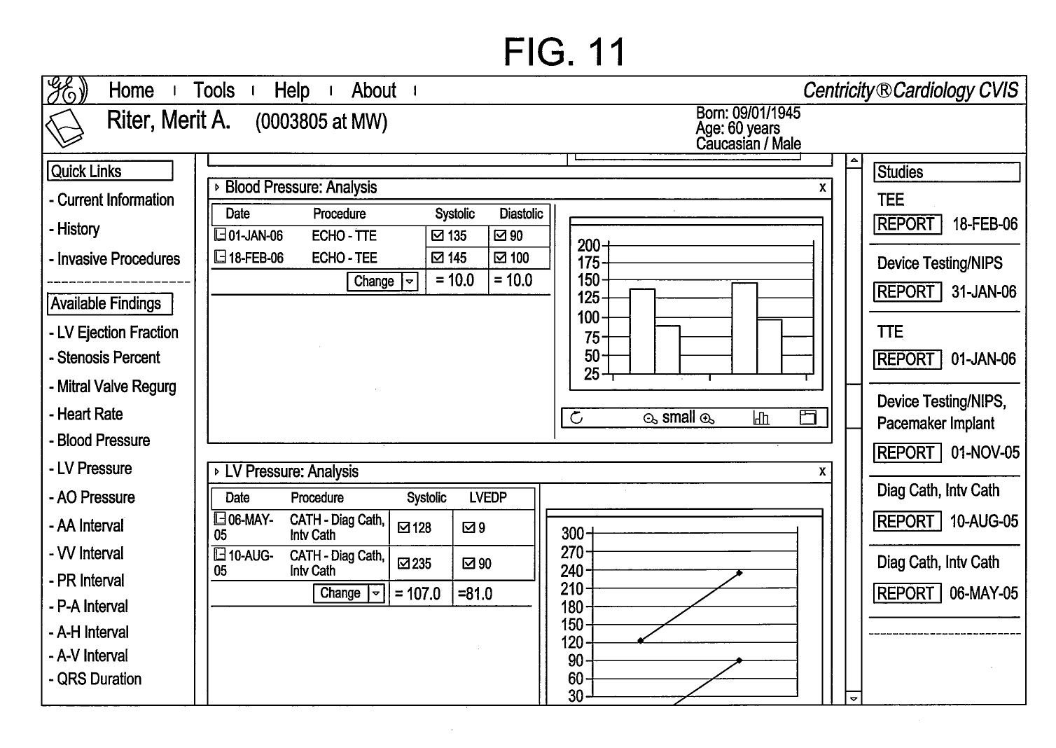

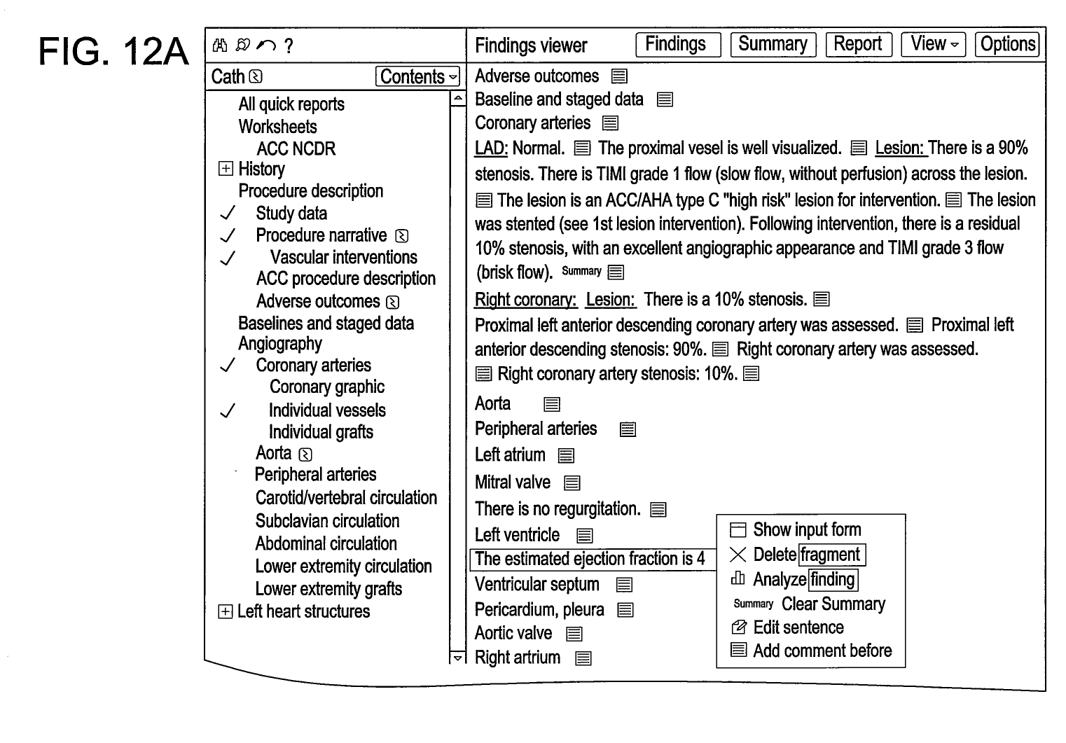

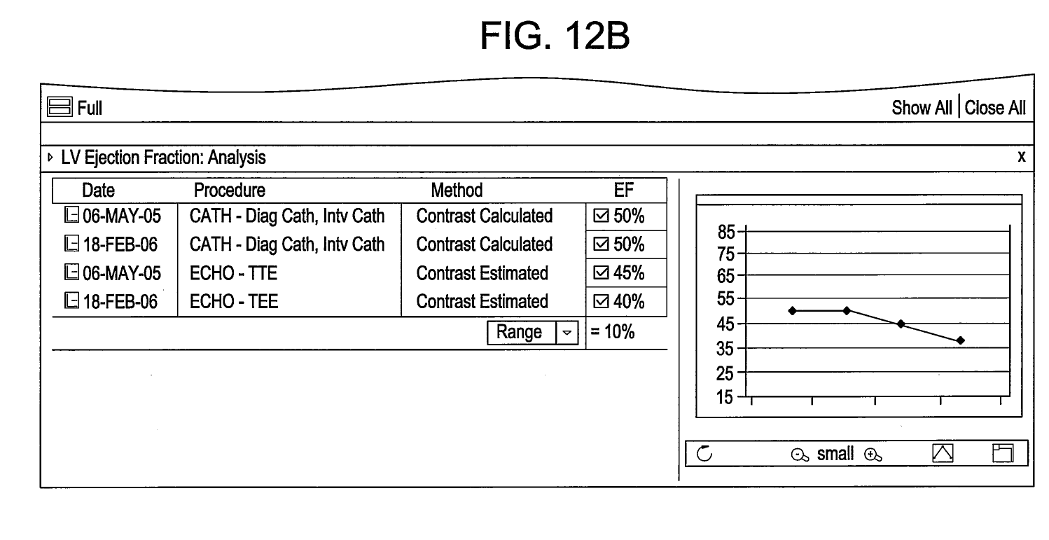

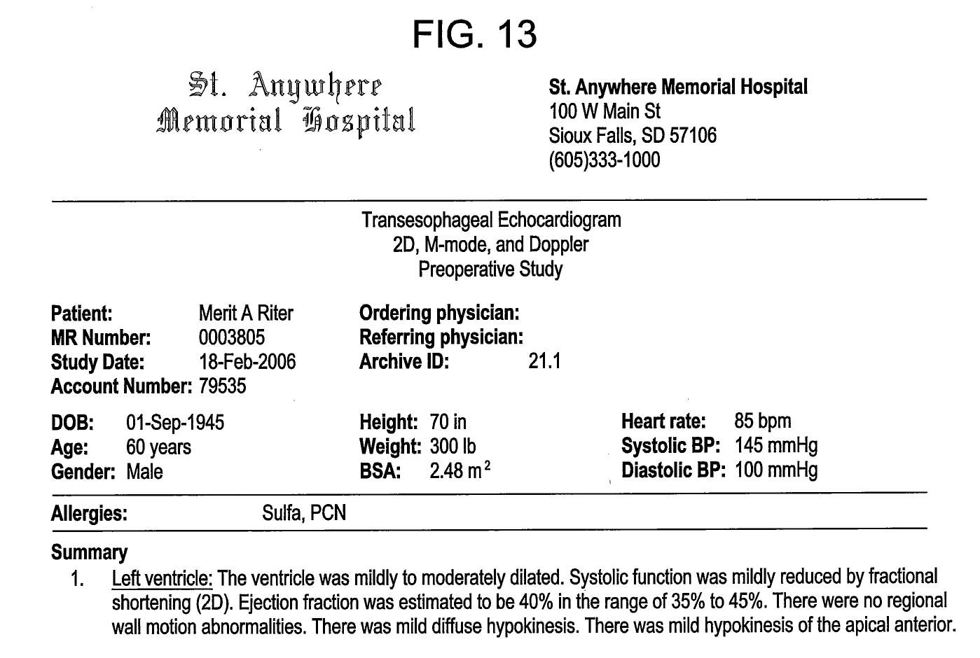

As illustrated in FIG. 10, both qualitative and quantitative data may be provided to help increase information available for practitioner decision-making. FIG. 11 helps to demonstrate that data may be depicted via a variety of graphics, including bar and line graphs, as well as alphanumerically, for example. In FIG. 12, case interaction for a patient is illustrated. A user may view a variety of clinical findings, add/edit/delete data, analyze one or more findings, generate or clear a summary, add a comment to a finding, etc. In FIG. 13, a physician report is generated and displayed, for example.

As shown above, data may be provided in quantitative, qualitative, graphical and/or other form, for example. Such data may be output, stored and/or otherwise utilized in other applications and/or analysis.

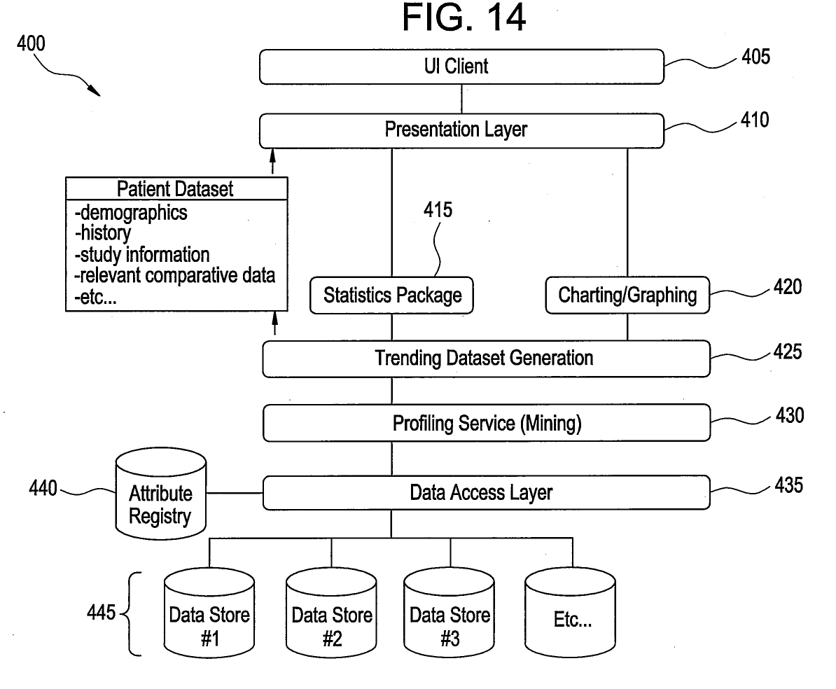

FIG. 14 illustrates an example representation of an architecture 400 for clinical data mining and analysis in accordance with an embodiment of the present invention. The architecture 400 represents a multi-tiered architecture, wherein each tier represents a potential machine separation, for example. In an embodiment, the architecture 400 includes a user interface (UI) client 405, a presentation layer 410, a statistics package 415, a charting/graphing module 420, a trending dataset generator 425, a profiling service 430, a data access layer 435, an attribute registry 440 and one or more data store(s) 445. In certain embodiments, the UI client 405 includes a Web client and a reporting tool, such as the Cyberpulse physician reporting tool. In certain embodiments, the presentation layer 410 includes a module generating hypertext markup language (HTML) and/or extensible stylesheet language (XSL) documents for display via an application service provider (ASP) based Web application. The presentation layer 410 may also include a cascading style sheet (CSS) and/or other page layout tool to generate content for display to a user. Data source(s) 445 may include one or more clinical databases, external clinical systems, electronic medical record, imaging modality, etc. Components of the architecture 400 may be implemented in various combinations in software, hardware and/or firmware, for example.

In operation, a user requests data for a patient via the UI client 405. Alternatively, data may be automatically requested in conjunction with a scheduled procedure or patient visit, for example. The request is routed to the data access layer 435, which retrieves data from one or more connected data sources 445. For example, ActiveX Data Objects technology may be used by the data access layer 435 to access and/or modify data stored in one or more relational and/or non-relational data sources 445. Data access may be facilitated according to an attribute registry 440, for example.

Data is retrieved by the data access layer 435 and routed to the profiling service 430. The profiling service 430 performs data mining to gather data from a variety of data source(s) 445 in relation to a particular patient. Data may be gathered with respect to a particular condition or characteristic as well. Mined data is passed to the trending dataset generator 425. The trending generator 425 analyzes the data to identify trending, relationships, and/or other characteristic(s) in the mined data for the patient. Trending data, as well as the original data itself, may then be used by the statistics package 415 and/or charting/graphing module 420 to generate alphanumeric and/or graphical data for use in displaying and/or reporting to a user, for example.

Thus, patient data including demographics, history, study information, relevant comparative data, etc., are passed to the presentation layer 410. The presentation layer formats the information for display to a user, such as in Web page and/or report format. The data is then displayed, stored, transmitted and/or further processed by one or more components including the UI client 405.

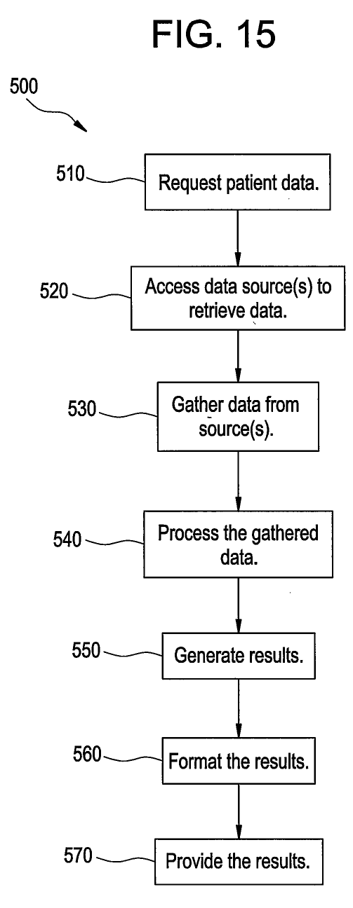

FIG. 15 illustrates a flow diagram for a method 500 for patient data mining in accordance with an embodiment of the present invention. At step 510, patient data is requested. Patient data may be requested by a user and/or automatically through a system, for example. Patient data may be requested, pre-, intra-, and/or post-operatively to aid a healthcare practitioner, for example.

At step 520, one or more data sources are accessed to retrieve data for the requested patient. For example, one or more databases, healthcare information systems, modalities, libraries, electronic medical records, etc., are accessed to retrieve data for an identified patient and/or other provided parameter. At step 530, data is gathered from the source(s).

At step 540, the gathered or mined data is processed. For example, trends (e.g., progression, regression, etc.) may be determined from the gathered data. Relationships among the gathered data may be determined. Statistics and/or other analysis may be generated. At step 550, results are generated based on the data and analysis. For example, alphanumeric and/or graphical results may be generated for display and/or further processing by a user or external tool. At step 560, results are formatted. For example, a Web page and/or other file may be generated to display the results. A report may be generated from the results, for example.

At step 570, results are provided to a user. For example, a Web application and/or reporting tool may provide results to a user and/or external system. Results data may be transmitted to a surgical planning tool and/or decision support system, for example. Results may be stored in an electronic patient record and/or other information system, for example. Results may be used to guide a healthcare practitioner in diagnosis, treatment and/or other planning, for example.

One or more of the steps of the method 500 may be implemented alone or in combination in hardware, firmware, and/or as a set of instructions in software, for example. Certain embodiments may be provided as a set of instructions residing on a computer-readable medium, such as a memory, hard disk, DVD, or CD, for execution on a general purpose computer or other processing device.

Certain embodiments of the present invention may omit one or more of these steps and/or perform the steps in a different order than the order listed. For example, some steps may not be performed in certain embodiments of the present invention. As a further example, certain steps may be performed in a different temporal order, including simultaneously, than listed above.

Thus, certain embodiments provide increased efficiency in a medical workflow through improved data mining and cross-source analysis. Certain embodiments provide a technical effect of data mining and decision support pre-, intra- and/or post-operatively from a plurality of data sources. Certain embodiments facilitate trending and comparison of clinical data from a plurality of sources. Certain embodiments help provide real-time information and analysis to aid in prediction, diagnosis and treatment of patient disorders.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A healthcare imaging and information management system with data mining capabilities, said system comprising:
a user interface accepting user input and displaying information related to a patient;
a data access layer gathering data related to said patient from a plurality of data sources; and
a data mining service processing said data for provision via said user interface.

2. The system of claim 1, further comprising a presentation layer formatting said data for provision via said user interface.

3. The system of claim 1, wherein said user interface comprises at least one of a Web client and a report generator.

4. The system of claim 1, further comprising a trending generator for trending said data.

5. The system of claim 1, further comprising at least one of a statistics engine and a charting/graphing module for processing said data.

6. The system of claim 1, wherein said data access layer gathers said data based at least in part on information from an attribute registry.

7. The system of claim 1, wherein said data is formatted for display based at least in part on a style sheet.

8. A method for clinical data mining in an imaging and information management system, said method comprising:
requesting data for a patient;
accessing a plurality of data sources to retrieve data related to said patient;
gathering data from said plurality of data sources;
processing said data;
formatting said data for a user; and
providing said data to the user.

9. The method of claim 8, wherein said processing step further comprises at least one of trending said data, profiling said data, charting said data and generating statistics from said data.

10. The method of claim 8, wherein said providing step further comprises at least one of providing said data via a Web page and providing said data via a report.

11. The method of claim 8, wherein said gathering step further comprises gathering said data based at least in part on an attribute from an attribute registry.

12. The method of claim 11, wherein said attribute comprises at least one of a data attribute and a data source attribute.

13. The method of claim 8, wherein said formatting step further comprises formatting said data for display based at least in part on a style sheet.

14. The method of claim 8, wherein said providing step further comprises providing said data to the user pre-operatively, intra-operatively and post-operatively via a user interface.

15. A computer-readable storage medium including a set of instructions for a computer, the set of instructions comprising:
a user interface routine accepting user input and displaying information related to a patient;
a data access layer gathering data related to said patient from a plurality of data sources; and
a data mining service processing said data for provision via said user interface.

16. The computer-readable storage medium of claim 15, further comprising a presentation layer formatting said data for provision via said user interface routine.

17. The computer-readable storage medium of claim 15, wherein said user interface routine comprises at least one of a Web client and a report generator.

18. The computer-readable storage medium of claim 15, further comprising a trending generator for trending said data.

19. The computer-readable storage medium of claim 15, further comprising at least one of a statistics engine and a charting/graphing module for processing said data.

20. The computer-readable storage medium of claim 15, wherein said data access layer gathers said data based at least in part on information from an attribute registry.
